(19) United States
(12) Patent Application Publication
(10) Pub. No.: US 2015/0174005 A1
(43) Pub. Date: Jun. 25, 2015

(54) MEDICAMENT CONTAINER AND DISPENSER

(71) Applicant: Sallie Piering, Midland, MI (US)

(72) Inventor: Sallie Piering, Midland, MI (US)

(21) Appl. No.: 14/550,044

(22) Filed: Nov. 21, 2014

Related U.S. Application Data
(60) Provisional application No. 61/915,557, filed on Dec. 13, 2013.

(51) Int. Cl. A61J 1/03; A45F 5/00

(52) U.S. Cl. CPC A61J 1/035; A45F 5/00; A45F 2005/008

(57) ABSTRACT

A medicament container comprising in combination, a support band and a hollow medicament retainer with a medicament blister pack. The device is a disposable (i.e. single use), inexpensive, pre-loaded, sealed, condition specific, wearable device such that it can be carried virtually anywhere that, the user goes.

### BACKGROUND OF THE INVENTION

The use of bracelets, rings, and necklaces, for example, for hiding or carrying medicaments or poisons, or the like, has been known for centuries. The concept of having medicaments on a person for emergencies is also not a new idea, in that, there are many devices being sold today to hold medicaments that can be used for emergencies, for example, aspirin, used for potential heart attack victims or nitro tablets for heart problems.

The devices of this invention provide a single use, pre-loaded, sealed, condition specific, wearable device for carrying medicaments.

This application claims priority from U.S. Provisional Patent application Ser. No. 61/915,557, filed on Dec. 13, 2013.

### THE INVENTION

What is therefore disclosed and claimed herein as the invention is a medicament, container comprising in combination, a support band and a hollow medicament retainer. The hollow medicament retainer is supported on the support band. The hollow medicament retainer has a top and an open bottom and the hollow in the hollow medicament retainer contains a blister pack having a bottom. The blister pack contains at least one solid medicament and the blister pack bottom has a breakable seal such that when the seal is broken, the solid medicament contained therein is dispensed.

### BRIEF DESCRIPTION OF THE DRAWINGS

FIG. 1 is a view in perspective of one device of this invention which is a bracelet.

FIG. 2 is a full end view of the device of FIG. 1.

FIG. 3A is a cross-sectional view of the device of FIG. 2 through line A-A.

FIG. 3B is a cross-sectional view of the device of FIG. 3A through line B-B.

FIG. 3C is a cross-sectional view as shown in FIG. 3A, except that the elastomer projections are not shown.

FIG. 4 is a full top view of the device of FIG. 1.

FIG. 5 is a full side view of the device of FIG. 1.

FIG. 6 is a device of this invention which is secured by a snap button.

FIG. 7 is a device of this invention which is secured by snap

FIG. 8 is a device of this invention which is secured by string.

FIG. 9 is a device of this invention which is secured by a hook and loop fastener.

FIG. 10 is a schematic of a device of this invention on a wrist.

FIG. 11 is a schematic of a device of this invention on an ankle.

FIG. 12 is a schematic of a device of this invention on an arm.

FIG. 13 is a schematic of a device of this invention on a leg.

FIG. 14 is a schematic of a device of this invention as a head band.

FIG. 15 is a schematic of a device of this invention as a hair tie.

FIG. 16 is a schematic of a device of this invention secured with a shoe lace.

FIG. 17 is a schematic of a device of this invention adaptable to a shoe lace.

FIG. 18 is a schematic of a device of this invention on a belt buckle.

FIG. 19 is a schematic of a device of this invention as a ring.

FIG. 20 is a schematic of a device of this invention as a necklace.

FIG. 21 is a securing device composed of an opening and a rounded peg.

### DETAILED DESCRIPTION OF THE INVENTION

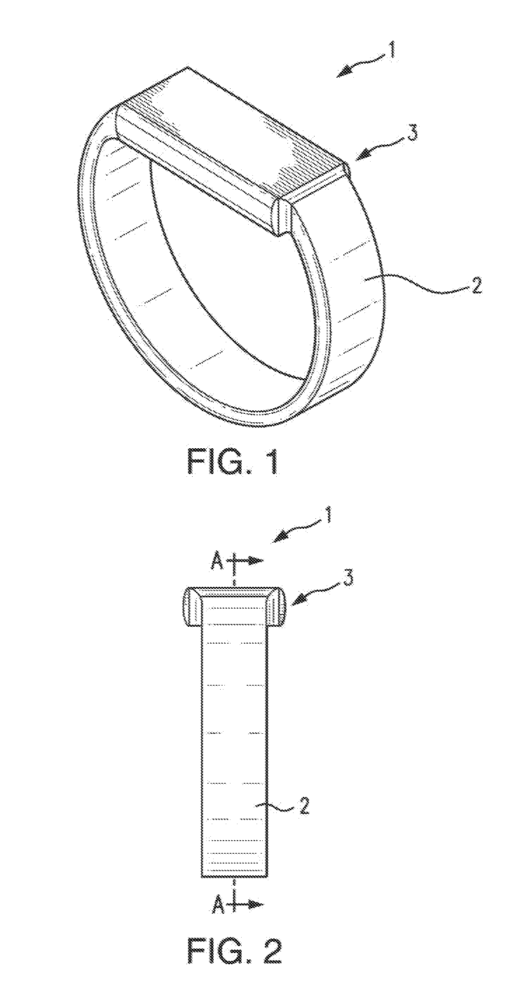

Turning now to FIGS. 1 to 3, one device of this invention, which is a (device of this invention) bracelet 1. Shown in these Figures are the support band 2. There is a medicament container 3. The support band 2 has the medicament container 3 supported on it. The medicament container 3 is comprised of a hollow medicament retainer 4 that has a top 5 and an open bottom 6 and the hollow in the hollow medicament retainer 4 contains a blister pack 8 having a bottom 9. The blister pack 8 contains at. least one solid medicament 7 and the blister pack bottom 9 has a breakable seal 11 such that when the seal 11 is broken, the solid medicament 7 contained therein is dispensed.

Although it is not critical, the medicament container 3 can be manufactured from such materials as elastomer, especially stretchable elastomer, wood, paper, cardboard, plastic, cloth, and the like. In some types, it is intended to be waterproof. The medicament container 3 can be manufactured such that it is disposable after one use, that is, after all the medicament is used.

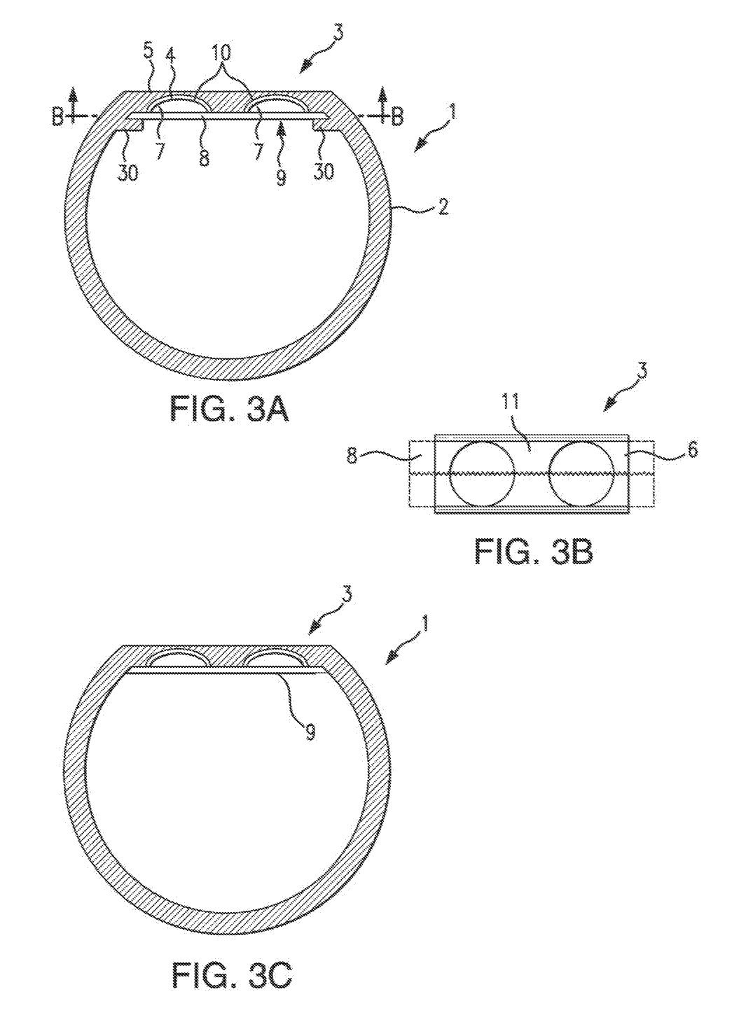

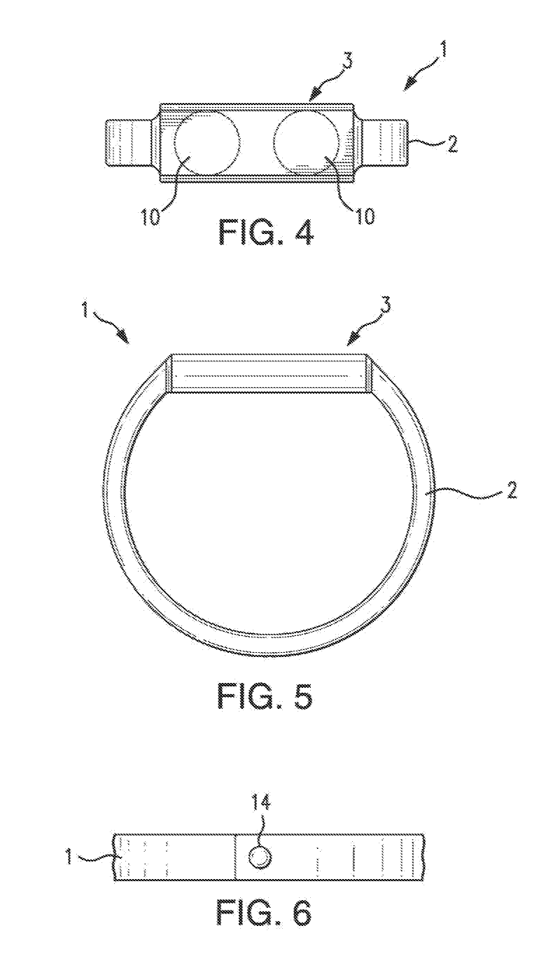

As shown, the device 1 in FIGS. 3A and 4 illustrate two spaces 10 for medicament, although, it is within the scope of this invention to have at least one space 10 and up to several spaces 10, depending on the size of the device 1 and the size of the medicament intended to be used therein.

Although the medicament container 3 does not necessary need a fastener to hold the support band 2 together, it is contemplated within the scope of this invention to use such fasteners. For example, one can use stretchable elastomer without any fastener whatsoever. Or, one can use stretchable elastomer wherein the support band is two-piece, and one end of the two-piece has an opening 12 in it that will fit over a peg 13 in the end of the other part of the two-piece, as illustrated in FIG. 21.

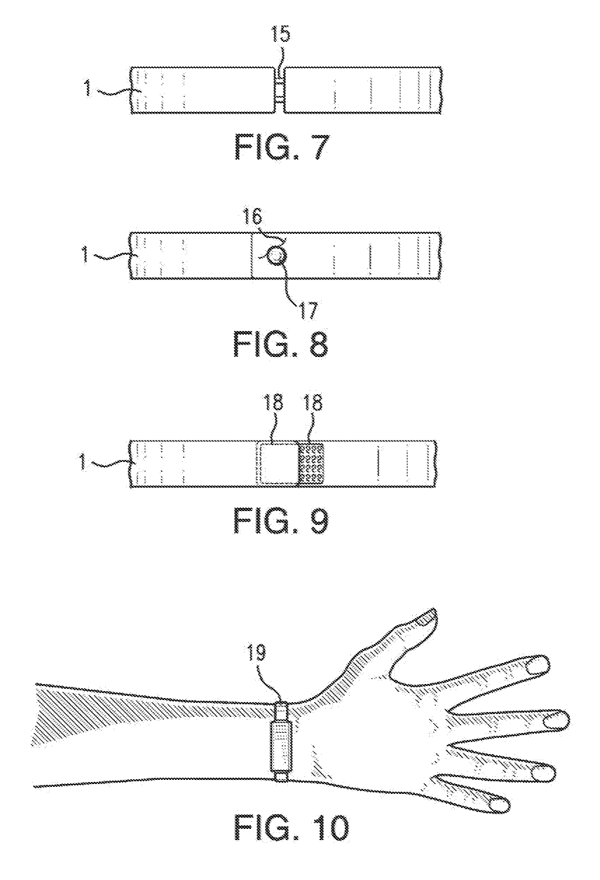

Further, the fastener can be a snap button 14 as illustrated in FIG. 6, a snap loch 15 as illustrated in FIG. 7, a string 16 and peg 17 as illustrated in FIG. 8, a hook and loop 18 arrangement as illustrated in FIG. 9.

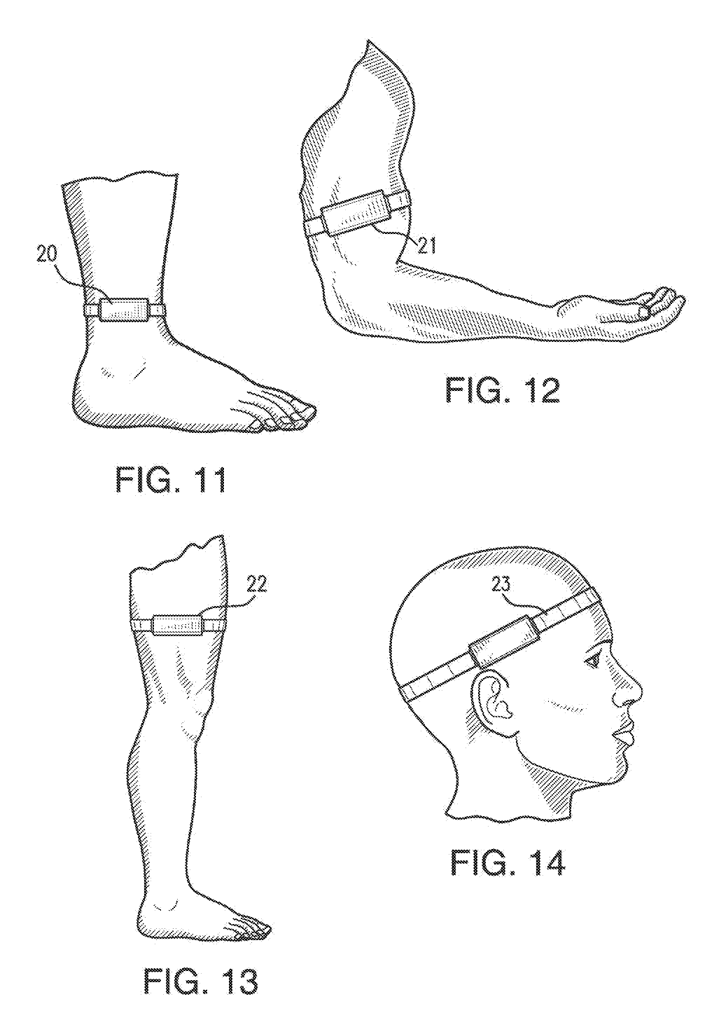

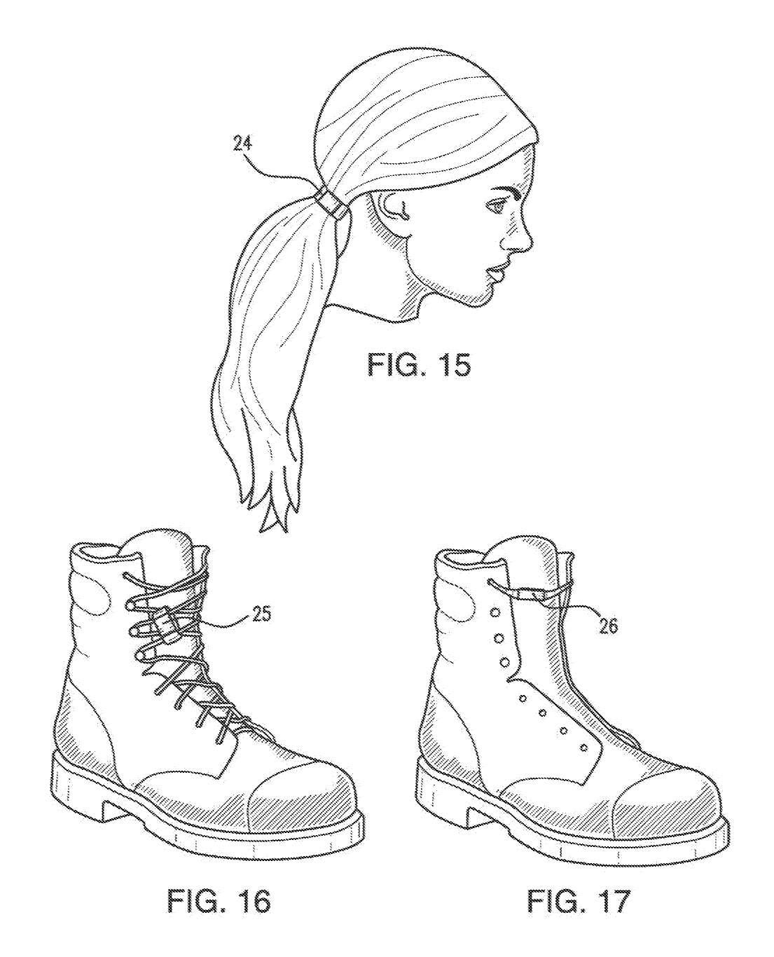

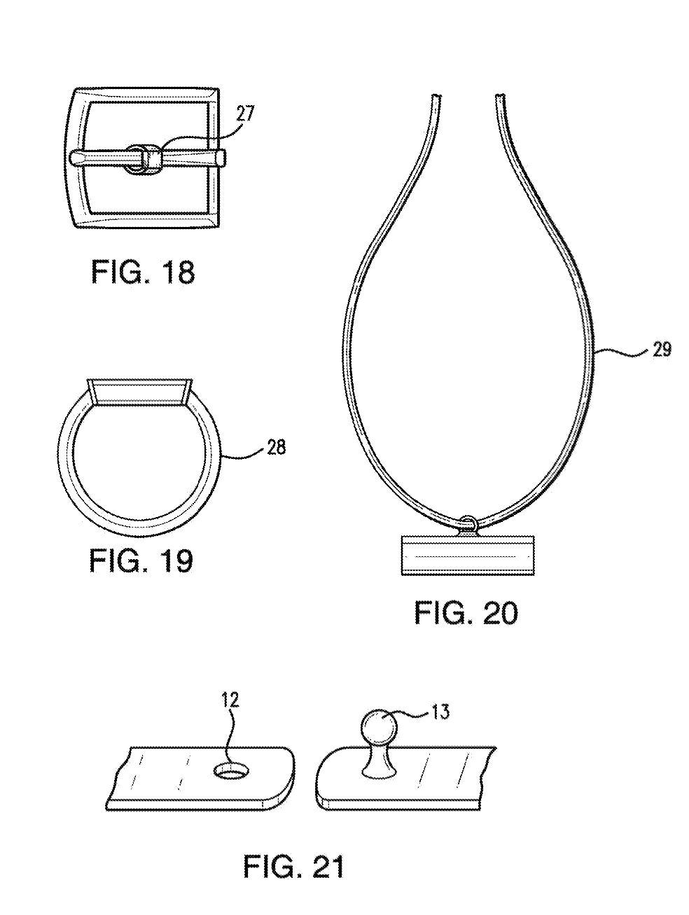

Although the device 1 is configured as a wrist band 19 as illustrated in FIG. 10, it can also be configured as an ankle band 20 as illustrated in FIG. 11, an arm band 21 as illustrated in FIG. 12, a leg band 22 as illustrated in FIG. 13, a head band 23 as illustrated in FIG. 14, a hair tie 24 as illustrated in FIG. 15, attached to a shoelace 25 as illustrated in FIG. 16, as a shoelace 26 as illustrated in FIG. 17, attached to a belt buckle 27 as illustrated in FIG. 18, a finger ring 28 as illustrated in FIG. 19, and a necklace 29 as illustrated in FIG. 20, to name a few uses contemplated herein.

The novel features of the devices of this invention are disposability (i.e. single use), inexpensive, pre-loaded, sealed, condition specific, wearable device such that it can be carried virtually anywhere that the user goes.

Another novel feature is the blister pack 8 of this device, in which the breakable seal 11 for the blister pack 8 is on the bottom of the device 1, and therefore, no cap or lid is needed on the device and access to the medicament is quick and easy.

Another novel feature is that the blister pack 8 can be held in place virtually by friction of the blister pack. 8 against the medicament retainer walls as illustrated in FIG. 3C. Note that in this Figure, the elastomer projections 30 as shown in FIG. 3A are missing in order to allow the frictional fit of the blister pack B.

An additional feature, of the band is that it serves a function as a medical alert band to alert people to the wearer's medical condition. The band also may include cars directions for heart attack care, for example. The two most important instructions on the band are to call emergency personal and for instructions on how and what to medicate.

What is claimed is:

1. A medicament container comprising in combination, a support band and a hollow medicament retainer, said hollow medicament retainer being supported on said support band
said hollow medicament retainer having a top and an open bottom and said hollow in said hollow medicament retainer containing a blister pack having a bottom, said blister pack containing at least one solid medicament and said blister pack bottom having a breakable seal such that when the seal is broken, the solid medicament contained therein is dispensed.

2. A medicament container as claimed in claim 1 wherein, in said hollow medicament retainer, the blister pack is friction supported.

3. A medicament container as claimed in claim 1 wherein, in said hollow medicament retainer, the blister pack is supported by elastomer projections.

4. A medicament container as claimed in claim 1 wherein said medicament container is waterproof.

5. A medicament container as claimed in claim 1 wherein said hollow medical retainer is large enough to hold at least one solid medicament.

6. A medicament container as claimed in claim 1 wherein said medicament container is manufactured from stretchable elastomer.

7. A medicament container as claimed in claim 1 wherein said support band is manufactured from stretchable elastomer.

8. A medicament container as claimed in claim 1 wherein said support band is held together using a snap button.

9. A medicament container as claimed in claim 1 wherein said support band is held together using a snap lock.

10. A medicament container as claimed in claim 1 wherein said support band is held together using a string.

11. A medicament container as claimed in claim 1 wherein said support band is held together using a hook and loop fastener.

12. A medicament container as claimed in claim 1 wherein said medicament container is configured for a human wrist.

13. A medicament container as claimed in claim 1 wherein said medicament container is configured for a human ankle.

14. A medicament container as claimed in claim 1 wherein said medicament container is configured for a human arm.

15. A medicament container as claimed in claim 1 wherein said medicament container is configured for a human leg.

16. A medicament container as claimed in claim 1 wherein said medicament container is configured for a human head band.

17. A medicament container as claimed in claim 1 wherein said medicament container is configured for a human hair tie.

18. A medicament container as claimed in claim 1 wherein said medicament container is configured as a shoelace.

19. A medicament container as claimed in claim 1 wherein said medicament container is configured to he adaptable to a shoe lace.

20. A medicament container as claimed in claim 1 wherein said medicament container is configured to be adaptable to a belt buckle.

21. A medicament container as claimed in claim 1 wherein said medicament container is a ring worn on a human digit.

22. A medicament container as claimed in claim 1 wherein said medicament container is a necklace.

23. A medicament container as claimed in claim 1 wherein said medicament container includes, in addition, medical alert information.

24. A medicament container as claimed in claim 1 wherein said medicament container contains, in addition medical care instructions.

25. A medicament container as claimed in claim 1 wherein said medicament container is manufactured from material that glows in the dark.
